(19) United States
(12) Patent Application Publication
(10) Pub. No.: US 2019/0043066 A1
(43) Pub. Date: Feb. 7, 2019

(54) INFORMATION PROCESSING SYSTEM, INFORMATION PROCESSING METHOD, AND INFORMATION PROCESSING PROGRAM

(71) Applicant: NEC CORPORATION, Tokyo (JP)

(72) Inventors: Keisuke UMEZU, Tokyo (JP); Hiroki NAKATANI, Tokyo (JP)

(73) Assignee: NEC CORPORATION, Tokyo (JP)

(21) Appl. No.: 16/075,238

(22) PCT Filed: Mar. 29, 2016
(86) PCT No.: PCT/JP2016/001811

§ 371 Date: Aug. 3, 2018

(51) Int. Cl. G06Q 30/02; G06N 7/00; G06N 3/08; G06F 17/18

(52) U.S. Cl. CPC G06Q 30/0202; G06F 17/18; G06N 3/08; G06N 7/00

(57) ABSTRACT

An information processing system 80 for predicting a prediction target using a predictive model including a variable that influences the prediction target includes a reception unit 81 and a specifying unit 82. The reception unit 81 receives designation of a plurality of prediction targets. The specifying unit 82 specifies, from among the designated plurality of prediction targets, a prediction target for which an element included in a corresponding predictive model shows a different tendency from other prediction targets.

### TECHNICAL FIELD

The present invention relates to an information processing system, an information processing method, and an information processing program for specifying a specific prediction target.

### BACKGROUND ART

Methods of performing various analyses based on a large amount of historical data are known. Point of sale (POS) data is an example of data representing the sales results of each store. For example, in the case where a company having 1000 retail stores throughout the country summarizes the sales amounts of each of 2000 types of products for each store per month, the number of pieces of POS data is 1000 (stores)×12 (months/year)×2000 (types/months·stores)=24,000,000 per year.

An example of a method of analyzing such POS data is a method that uses a summarization tool having a function like EXCEL® pivot tables. By feeding POS data into such a summarization tool, a user can summarize the product sales amounts from various perspectives such as for each store, for each season, or for each product, and freely analyze factors contributing to sales ranging from a microscopic point of view to a macroscopic point of view.

Other examples of known software dedicated to such statistics include Tableau®, SAS®, and SPSS®.

Patent Literature (PTL) 1 describes a device for predicting characteristics of a product. The device described in PTL 1 predicts, from a stored feature value, a characteristic value representing characteristics of a product using a predictive model, and outputs the predicted characteristic value as a characteristic predictive value. Here, the predictive model is learned and updated so as to reduce the error between the characteristic predictive value and the characteristic value.

### CITATION LIST

### Patent Literature

PTL 1: Japanese Patent Application Laid-Open No. 2011-071296

### SUMMARY OF INVENTION

### Technical Problem

If a target having a specific property can be extracted from among a plurality of prediction targets, it is possible to make various future strategies and examinations based on the specific prediction target. However, since prediction results often change depending on input data, it is difficult to extract a prediction target having a specific property by simply using prediction results.

For example, the device described in PTL 1 can be used to predict characteristics of a product. However, the device described in PTL 1 is not intended to determine which prediction target has a specific property.

The present invention therefore has an object of providing an information processing system, an information processing method, and an information processing program that can specify a specific prediction target from among a plurality of prediction targets.

### Solution to Problem

An information processing system according to the present invention is an information processing system for predicting a prediction target using a predictive model including a variable that influences the prediction target, the information processing system including: a reception unit which receives designation of a plurality of prediction targets; and a specifying unit which specifies, from among the designated plurality of prediction targets, a prediction target for which an element included in a corresponding predictive model shows a different tendency from other prediction targets.

An information processing method according to the present invention is an information processing method for predicting a prediction target using a predictive model including a variable that influences the prediction target, the information processing method including: receiving designation of a plurality of prediction targets; and specifying, from among the designated plurality of prediction targets, a prediction target for which an element included in a corresponding predictive model shows a different tendency from other prediction targets.

An information processing program according to the present invention is an information processing program used in a computer for predicting a prediction target using a predictive model including a variable that influences the prediction target, the information processing program causing the computer to execute: a reception process of receiving designation of a plurality of prediction targets; and a specifying process of specifying, from among the designated plurality of prediction targets, a prediction target for which an element included in a corresponding predictive model shows a different tendency from other prediction targets.

### Advantageous Effects of Invention

According to the present invention, it is possible to specify a specific prediction target from among a plurality of prediction targets.

### BRIEF DESCRIPTION OF DRAWINGS

FIG. 1 is a block diagram depicting a structural example of Exemplary Embodiment 1 of an information processing system according to the present invention.

FIG. 2 is an explanatory diagram depicting an example of storing prediction targets and a plurality of classifications in association with each other.

FIG. 3 is an explanatory diagram depicting an example of predictive models of prediction targets.

FIG. 4 is an explanatory diagram depicting an example of a process of specifying prediction targets.

FIG. 5 is a flowchart depicting an operation example of an information processing system in Exemplary Embodiment 1.

FIG. 6 is an explanatory diagram depicting an example of groups to which explanatory variables belong.

FIG. 7 is a flowchart depicting an operation example of an information processing system in Exemplary Embodiment 2.

FIG. 8 is a flowchart depicting an operation example of an information processing system in Exemplary Embodiment 3.

FIG. 9 is a flowchart depicting an operation example of an information processing system in Exemplary Embodiment 4.

FIG. 10 is an explanatory diagram depicting an example of an output result screen.

FIG. 11 is a block diagram schematically depicting an information processing system according to the present invention.

### DESCRIPTION OF EMBODIMENT

For example, POS data mentioned above is typically used in sales analysis. With a method of performing various analyses based on a large amount of historical data as described above, however, it is merely possible to analyze sales (i.e. results) themselves on a store basis, on a product basis, or on a period basis.

The inventors of the present application have identified a new issue of performing finer analysis and extracting, as a specific prediction target, a prediction result having a different contributory factor from other prediction results. The inventors have conceived an idea of extracting a specific prediction target by using a large number of predictive models themselves, in order to, for example in sales analysis, find an exceptional prediction target that differs from other prediction targets in its factor contributory to sales, on a store basis, on a product basis, or on a period basis. A predictive model appropriately learned based on historical data is considered to reflect the property of the historical data appropriately. Based on such predictive models, factors that can contribute to prediction targets can be analyzed.

The inventors have also conceived an idea of focusing not only on prediction results but also on elements constituting predictive models, in order to find an exceptional prediction target. There are various perspectives for finding an exceptional prediction target. Examples of an object of the present invention are described below, using a concrete example relating to store sales.

A first object example may be finding an exceptional store. For example, suppose beverage X is sold in 5000 stores in Kanagawa Prefecture. Also suppose the sales of beverage X is positively correlated with maximum temperature for 4999 stores out of the 5000 stores, whereas the sales of beverage X is negatively correlated with maximum temperature for the remaining one store alone. In this case, this store can be determined as an exception.

The extraction of such an exception, for example, helps determining if a predictive formula for predicting the sales of beverage X in the exceptional store is somewhat inaccurate. Moreover, the extraction of such an exception, for example, helps a person in charge of analysis noticing the fact that the exceptional store mounted some kind of campaign on its own on a day with low maximum temperature: the fact the person was unaware of.

A second object example may be finding an exceptional product. For example, suppose apple juice, orange juice, pine juice, grape juice, and peach juice are subclassifications of fruit juice beverage. Also suppose orange juice, pine juice, and grape juice each differ significantly in sales tendency between weekdays and holidays, whereas the sales of peach juice alone is hardly dependent on whether weekdays or holidays. In this case, peach juice can be determined as an exception.

The extraction of such an exception, for example, helps determining if a predictive formula for predicting the sales of the exceptional peach juice is somewhat inaccurate, as in the first object example. Moreover, the extraction of such an exception, for example, helps determining whether or not the sales tendency of the peach juice is substantially different from the sales tendency of the other fruit juice beverages.

A third object example may be finding an exceptional product group. For example, suppose there are fruit juice beverage { subclassifications “apple juice”, “orange juice”, “pine juice”, “grape juice”, “peach juice”, etc.}, carbonated beverage { . . . }, coffee { . . . }, and mineral water { . . . }.

For example, suppose 90 percent of the elements (“apple juice”, “orange juice”, etc.) included in the fruit juice beverage classification have a very strong correlation between price reduction and sales amount, 95 percent of the elements included in the coffee classification have a very strong correlation between price reduction and sales amount, and 99 percent of the elements included in the carbonated beverage classification have a very strong correlation between price reduction and sales amount, whereas only 30 percent of the constituent elements in the mineral water classification have a very strong correlation between price reduction and sales amount. In this case, the mineral water product group can be determined as an exception.

The extraction of such an exception, for example, helps determining whether or not the sales tendency of the exceptional mineral water group is substantially different from the sales tendency of the other product groups, as in the second object example.

As described in these object examples, an object of the present invention is to analyze the contribution of each factor to prediction targets and also find an exceptional prediction target having a different contributory factor from the other prediction targets. In other words, an object of the present invention is to find a prediction target whose predictive model structure (a variable included in the predictive model, a coefficient of the variable, etc.) shows a different tendency from the other prediction targets.

The extraction of such an exceptional predictive model enables noticing some kind of error or need for correction. The extraction of such an exceptional predictive model also helps noticing not only an error of the predictive model itself but also that the prediction target predicted by such an exceptional predictive model has a tendency substantially different from the other prediction targets.

Exemplary embodiments of the present invention are described below, with reference to drawings. In the following description, it is assumed that each prediction target is predicted using a predictive model, and the predictive model has already been learned based on past historical data and the like beforehand. One prediction target is associated with one predictive model.

A predictive model is information representing the correlation between an explanatory variable and an objective variable. For example, the predictive model is a component for predicting the result of the prediction target by calculating the objective variable based on the explanatory variable. The predictive model is generated by a learner, with learning data for which the value of the objective variable has already been obtained and given parameters as input. The predictive model may be expressed by, for example, a function c that maps an input x to a correct solution y. The predictive model may predict the numerical value of the prediction target, or the label of the prediction target. The predictive model may output a variable describing the probability distribution of the objective variable. The predictive model is also referred to as “model”, “learning model”, “estimation model”, “predictive formula”, “estimation formula”, or the like.

In the exemplary embodiments, the predictive model is expressed by a predictive formula including at least one explanatory variable indicating a factor that can contribute to the prediction result of the prediction target. The predictive model, for example, represents an objective variable by a linear regression equation including a plurality of explanatory variables. In the foregoing example, the correct solution y corresponds to an objective variable, and the input y corresponds to an explanatory variable. For example, the maximum number of explanatory variables included in one predictive model may be limited in order to enhance the interpretation of the predictive model or prevent overfitting. The number of predictive formulae used to predict one predictive target is not limited to one, and a case-analysis predictor with which a predictive formula is selected depending on a value of an explanatory variable may be used as the predictive model, as described later.

### Exemplary Embodiment 1

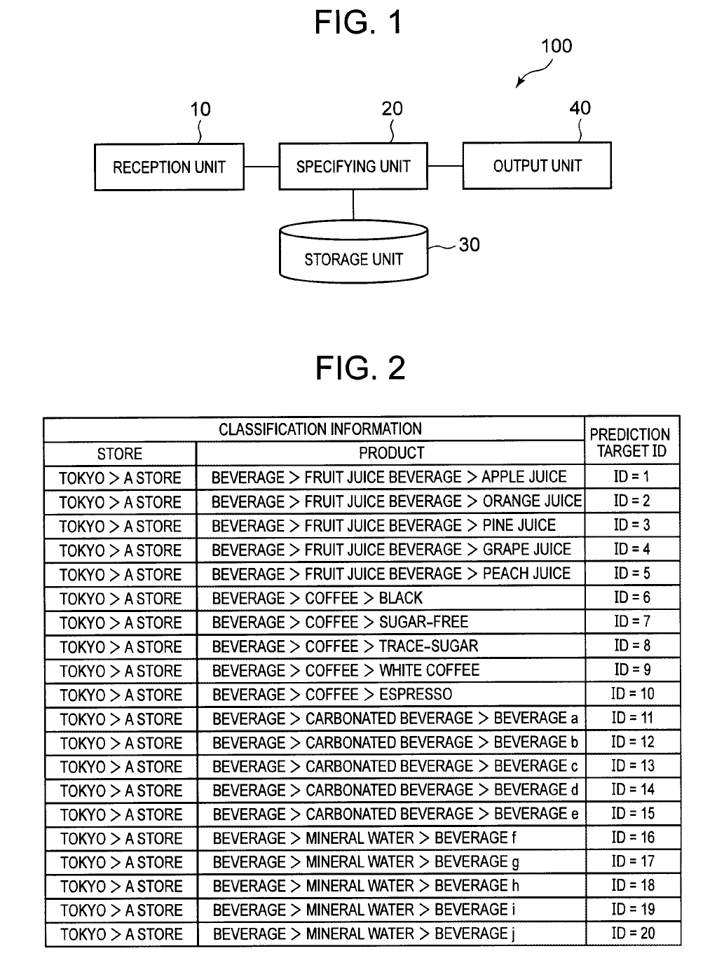

FIG. 1 is a block diagram depicting a structural example of Exemplary Embodiment 1 of an information processing system according to the present invention. An information processing system 100 in this exemplary embodiment includes a reception unit 10, a specifying unit 20, a storage unit 30, and an output unit 40.

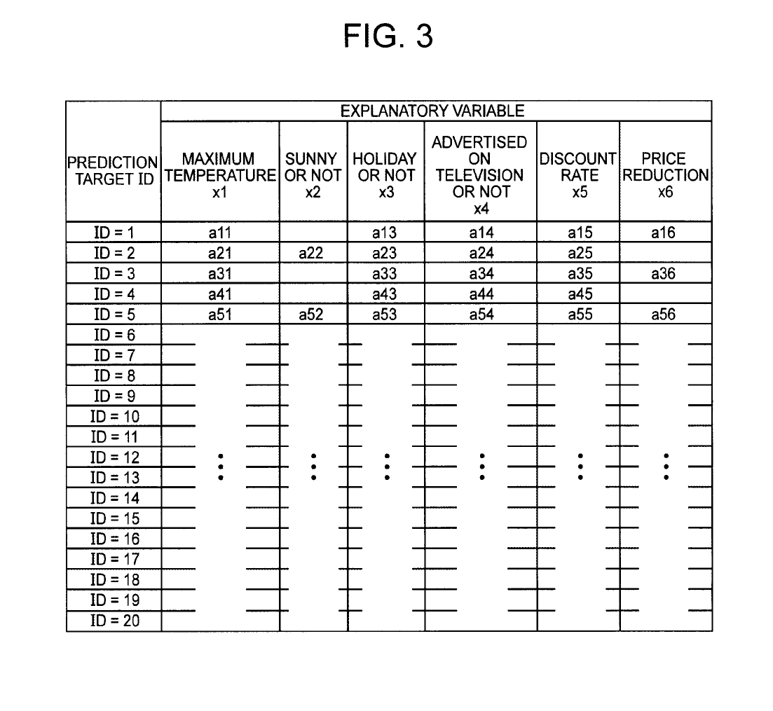

The storage unit 30 stores a predictive model for each prediction target. Exemplary Embodiment 1 describes an example in which a predictive model is represented by a linear regression equation. FIGS. 2 and 3 are each an explanatory diagram depicting an example of information stored in the storage unit 30. The storage unit 30 may store prediction targets and classifications in association with each other.

FIG. 2 depicts an example in which the storage unit 30 stores prediction targets and prediction target classifications in association with each other. In the example depicted in FIG. 2, the prediction targets are uniquely identified by prediction target IDs, and each prediction target ID is associated with classifications in hierarchical manner. For example, the prediction target identified by prediction target ID=1 is apple juice sold in A store in Tokyo, and apple juice is classified as fruit juice beverage in beverages. The sign “>” in the classification information depicted in FIG. 2 indicates a hierarchical relationship between classifications.

FIG. 3 is an explanatory diagram depicting an example of predictive models stored in the storage unit 30. In the example depicted in FIG. 3, the prediction targets are listed in the vertical direction of the table, and the weights (i.e. coefficients) of the explanatory variables representing the predictive models of the prediction targets are listed in the horizontal direction of the table. In the example depicted in FIG. 3, each predictive model is represented using any of explanatory variables X₁ “maximum temperature”, X₂ “sunny or not”, X₃ “holiday or not”, X₄ “advertised on television or not”, X₅ “discount rate”, and X₆ “price reduction”.

For example, the predictive model of the prediction target identified by prediction target ID=1 in FIG. 3 is represented using explanatory variables X₁ “maximum temperature”, X₃ “holiday or not”, X₄ “advertised on television or not”, X₅ “discount rate”, and X₆ “price reduction”, the respective weights of which are a₁₁, a₁₃, a₁₄, a₁₅, and a₁₆. For example, in the case where each predictive model is represented by a linear regression equation, when a value to be predicted is denoted by Y, the predictive model is represented by Y=a₁₁X₁+a₁₃X₃+a₁₄X₄+a₁₅X₅+a₁₆X₆.

The storage unit 30 is, for example, implemented by a magnetic disk device. The output unit 40 outputs a specifying result by the specifying unit 20. The output unit 40 may also receive an input from a user in response to the output result. The output unit 40 is, for example, implemented by a display device or a touch panel.

The reception unit 10 receives designation of a plurality of prediction targets. The reception unit 10 may receive designation of the plurality of prediction targets individually, or receive the classification of the prediction targets. The reception unit 10 in this exemplary embodiment also receives designation of an element (perspective for finding an exception) subjected to analysis of a specific prediction target from among the elements constituting each predictive model.

For example, in the case where the user wants to extract a specific prediction target from the perspective of “maximum temperature” from among the prediction targets classified as fruit juice beverage, the reception unit 10 receives designation of “fruit juice beverage subclassification” and “maximum temperature”.

The specifying unit 20 specifies a prediction target based on the designation received by the reception unit 10, and specifies a predictive model of the specified prediction target. In detail, the specifying unit 20 specifies the predictive model of the prediction target from the storage unit 30.

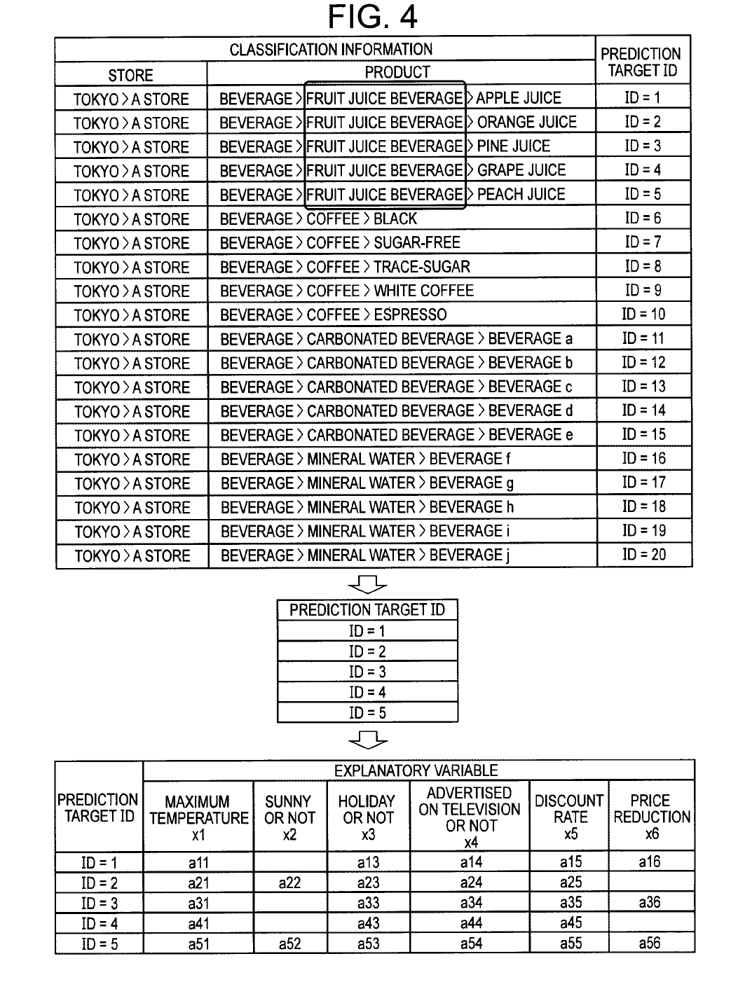

FIG. 4 is an explanatory diagram depicting an example of a process of specifying prediction targets from the information depicted in FIGS. 2 and 3 based on the received designation. Suppose the reception unit 10 receives designation of “fruit juice beverage subclassification”. The specifying unit 20 responsively specifies prediction targets with prediction target ID=1 to 5 including “fruit juice beverage” in the product classification from the table depicted in FIG. 2. Thus, in the case where a classification is designated, the specifying unit 20 specifies prediction targets included in all subclassifications belonging to the designated classification. The specifying unit 20 then specifies the predictive models of the prediction targets from the table depicted in FIG. 3.

Following this, the specifying unit 20 specifies, from among the specified predictive models, a prediction target for which the contents derived from the designated perspective (i.e. explanatory variable) show a different tendency from the other prediction targets. In other words, the specifying unit 20 specifies, from among the designated plurality of prediction targets, a prediction target for which the designated explanatory variable which is one of the elements constituting the corresponding predictive model shows a different tendency from the other prediction targets.

For example, in the case where each predictive model is represented by a linear regression equation, the specifying unit 20 specifies a prediction target for which the type of the variable included in the corresponding predictive model or the coefficient of the variable shows a different tendency from the other elements.

The following describes a concrete example of a method of specifying whether or not an element included in a predictive model differs from that of the other prediction targets in this exemplary embodiment. The specifying method is, however, not limited to the below-mentioned example. Any method capable of comparing tendencies between predictive models based on an element included in each predictive model may be used.

Here, a concrete example of the specifying method is described using the terms “category-type determination criterion” and “numeric-type determination criterion”, for the sake of convenience. The “category-type determination criterion” is a determination criterion using information indicating whether or not a designated explanatory variable is included in a predictive model and, in the case where the designated explanatory variable is included, whether the coefficient of the explanatory variable is positive or negative. This determination criterion can be regarded as a criterion based on the type of the variable. For example, in the case where the designated explanatory variable is not included in the predictive model, the predictive model of the target is classified under “0”. In the case where the explanatory variable is included and the coefficient is positive, the predictive model of the target is classified under “1”. In the case where the explanatory variable is included and the coefficient is negative, the predictive model of the target is classified under “2”.

The “numeric-type determination criterion” is a determination criterion using the absolute value of the coefficient of the designated explanatory variable. This determination criterion can be regarded as a criterion based on the coefficient of the variable. A determination criterion that combines a “category-type determination criterion” and a “numeric-type determination criterion” may be used.

Suppose fruit juice beverage subclassifications are { apple juice, orange juice, pine juice, grape juice, peach juice, . . . }, as mentioned above. Also suppose these beverages which are prediction targets are each associated with a predictive model represented by a linear regression equation, and the reception unit 10 receives designation of “maximum temperature” as an analysis perspective.

First, the “category-type determination criterion” is described below. For example, in the case where predictive models classified under some value (e.g. predictive models classified under “0” because the designated explanatory variable is not included in the predictive models) are less than a predetermined proportion threshold (e.g. 2% of the whole), the specifying unit 20 specifies the predictive models of the classification. In detail, the specifying unit 20 specifies that the prediction targets corresponding to the predictive models show a different tendency from the other prediction targets.

Moreover, for example, suppose there are 100 types of fruit juice beverages as fruit juice beverage subclassifications. Also suppose, of these, 98 types have a positive coefficient for maximum temperature, one type does not use a variable of maximum temperature, and the remaining one type has a negative coefficient for maximum temperature. In this case, the specifying unit 20 specifies the one type that does not use a variable of maximum temperature and one type that has a negative coefficient for maximum temperature, each as showing a different tendency from the other prediction targets.

Next, the “numeric-type determination criterion” is described below. For example, the specifying unit 20 may calculate a standard deviation of the coefficient of the designated variable. The specifying unit 20 may then specify a predictive model that is less than a predetermined threshold or greater than a predetermined threshold in the case of evaluating the coefficient of the designated explanatory variable by the standard deviation, as showing a different tendency from the other prediction targets.

For example, suppose there are 100 types of fruit juice beverages as fruit juice beverage subclassifications, and all of the 100 types have a positive coefficient for maximum temperature. Also suppose, of the 100 types, 99 types have a coefficient in a range of +10000 to +40000, whereas the remaining one type has a coefficient of +530000. In this case, the specifying unit 20 specifies the predictive model having a coefficient of +530000, as showing a different tendency from the other prediction targets.

The output unit 40 may output the prediction target specified as showing a different tendency from the other prediction targets. The output unit 40 may not only output the specified prediction target, but also output the prediction targets received by the reception unit 10 and highlight the specified prediction target from among the prediction targets.

For example, in the case where the specifying unit 20 calculates a standard deviation of a coefficient of a variable of each predictive model to evaluate the predictive model, the output unit 40 may output the calculated value of the standard deviation of the coefficient of the variable for each predictive model (prediction target), or output a heat map corresponding to the value of the standard deviation. Outputting the heat map enables the user to easily recognize a prediction target showing a different tendency from the other prediction targets.

The reception unit 10 and the specifying unit 20 are implemented by a CPU in a computer operating according to a program (information processing program). For example, the program may be stored in the storage unit 30, with the CPU reading the program and, according to the program, operating as the reception unit 10 and the specifying unit 20. The functions of the information processing system may be provided in the form of SaaS (Software as a Service).

The reception unit 10 and the specifying unit 20 may each be implemented by dedicated hardware. All or part of the components of each device may be implemented by general-purpose or dedicated circuitry, processors, or combinations thereof. They may be configured with a single chip, or configured with a plurality of chips connected via a bus. All or part of the components of each device may be implemented by a combination of the above-mentioned circuitry or the like and program.

In the case where all or part of the components of each device is implemented by a plurality of information processing devices, circuitry, or the like, the plurality of information processing devices, circuitry, or the like may be centralized or distributed. For example, the information processing devices, circuitry, or the like may be implemented in a form in which they are connected via a communication network, such as a client-and-server system or a cloud computing system.

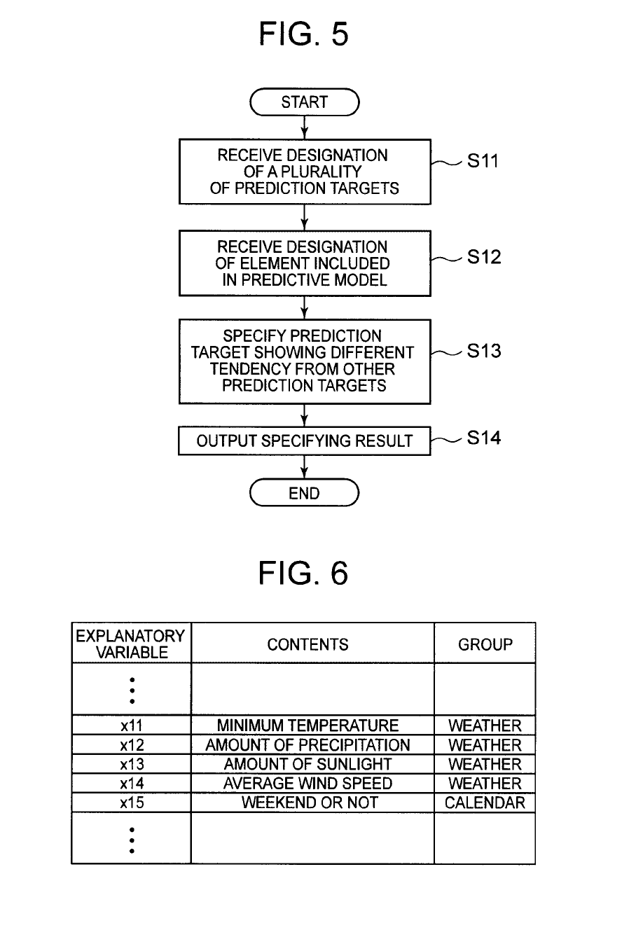

The operation of the information processing system in this exemplary embodiment is described below. FIG. 5 is a flowchart depicting an operation example of the information processing system 100 in Exemplary Embodiment 1. First, the reception unit 10 receives designation of a plurality of prediction targets (step S11). The reception unit 10 also receives designation of an element included in a predictive model, as an analysis perspective (step S12).

Next, the specifying unit 20 specifies, from among the designated plurality of prediction targets, a prediction target for which the element included in the corresponding predictive model shows a different tendency from the other prediction targets (step S13). In detail, the specifying unit 20 specifies a prediction target with the designated element showing a different tendency from the other prediction targets. The output unit 40 outputs the specifying result (step S14).

As described above, in this exemplary embodiment, the reception unit 10 receives designation of a plurality of prediction targets and an element included in a predictive model. The specifying unit 20 specifies, from among the designated plurality of prediction targets, a prediction target for which the designated element included in the corresponding predictive model shows a different tendency from the other prediction targets. With such a structure, a specific prediction target can be specified from among a plurality of prediction targets.

By use of the present invention, an analyst can extract a predictive model that has some kind of error and needs to be corrected, from among a large number of predictive models. Moreover, by use of the present invention, the analyst can extract, from among a large number of prediction targets, a prediction target showing a substantially different tendency from the other prediction targets.

A modification of Exemplary Embodiment 1 is described below. In this modification, a group to which a variable which is an element included in a predictive model described in Exemplary Embodiment 1 belongs is defined. Groups are set beforehand depending on variables.

FIG. 6 is an explanatory diagram depicting an example of groups to which explanatory variables belong. In the example depicted in FIG. 6, explanatory variable X₁₁ representing minimum temperature, explanatory variable X₁₂ representing the amount of precipitation, explanatory variable X₁₃ representing the amount of sunlight, and explanatory variable X₁₄ representing average wind speed all belong to group “weather”. The contents in FIG. 6 are merely an example of groups, and groups are set depending on explanatory variables used in predictive models.

In this modification, the reception unit 10 receives designation of a group (i.e. a group of one or more explanatory variables) mentioned above, as an element subjected to analysis. Following this, the specifying unit 20 specifies, from the received group, each explanatory variable belonging to the group, as an element subjected to analysis. The specifying unit 20 then specifies, for each specified element, a prediction target for which the contents derived from the element show a different tendency from the other prediction targets.

For example, suppose the groups depicted in FIG. 6 are defined. The reception unit 10 receives, from the user, designation of “weather” which is an explanatory variable group, as an analysis perspective. The specifying unit 20 specifies X₁₁ to X₁₄ (i.e. minimum temperature, amount of precipitation, amount of sunlight, and average wind speed) which are explanatory variables belonging to the group “weather”. Subsequently, the specifying unit 20 performs the process described in Exemplary Embodiment 1 (i.e. the process of specifying a prediction target showing a different tendency from the other prediction targets).

The output unit 40 outputs, for example, the following results: “For the minimum temperature, apple juice is an exception.”“For the amount of precipitation, there is no exception (in the fruit juice beverage subclassifications).”“For the amount of sunlight, pine juice is an exception.”

“For the average wind speed, there is no exception.”

As described above, in this modification, the reception unit 10 receives designation of a group of one or more explanatory variables as an element subjected to analysis. The specifying unit 20 specifies, from the received group, each explanatory variable belonging to the group as an element subjected to analysis. The specifying unit 20 then specifies, for each specified element, a prediction target for which the contents derived from the element show a different tendency from the other prediction targets. With such a structure, too, a specific prediction target can be specified from among a plurality of prediction targets.

### Exemplary Embodiment 2

Exemplary Embodiment 2 of an information processing system according to the present invention is described below. The structure in Exemplary Embodiment 2 is the same as the structure in Exemplary Embodiment 1. In this exemplary embodiment, however, the reception unit 10 does not receive designation of an element included in a predictive model (i.e. designation of an element subjected to analysis for a specific prediction target).

In this case, the specifying unit 20 specifies, from among the designated plurality of prediction targets, a prediction target for which the element included in the corresponding predictive model shows a different tendency from the other prediction targets.

For example, in the case where each predictive model is represented by a linear regression equation, the specifying unit 20 specifies a prediction target for which the type of the variable included in the corresponding predictive model or the coefficient of the variable shows a different tendency from the other elements, as in Exemplary Embodiment 1.

The following describes a concrete example of a method of specifying whether or not an element included in a predictive model differs from that of the other prediction targets in Exemplary Embodiment 2. The specifying method is, however, not limited to the below-mentioned example. Any method capable of comparing tendencies between predictive models based on an element included in a predictive model may be used, as in Exemplary Embodiment 1.

A concrete example in which the specifying unit 20 specifies a prediction target for which the type of the variable included in the corresponding predictive model shows a different tendency from the other elements is described below. For example, suppose orange juice is sold in 26 stores of {A store, B store, C store, . . . , Z store}, and a predictive model for predicting the sales of orange juice in each store is composed of a multiple regression equation of tenth order (i.e. predictive formula with 10 explanatory variables). Also suppose the respective predictive models for predicting the sales of orange juice of A store to Y store each have calendar-based explanatory variables or temperature-based explanatory variables occupying 50 percent to 70 percent of the 10 explanatory variables constituting the predictive formula, whereas the predictive model for predicting the sales of orange juice in Z store has only two calendar-based explanatory variables or temperature-based explanatory variables out of the 10 explanatory variables. In this case, the specifying unit 20 specifies the predictive model for predicting the sales of orange juice in Z store as showing a different tendency from the other prediction targets.

Thus, the specifying unit 20 may specify a prediction target for which the type of the variable included in the corresponding predictive model shows a different tendency from the other elements. Alternatively, the specifying unit 20 may specify a prediction target for which the coefficient of the variable included in the corresponding predictive model shows a different tendency from the other elements. As a determination criterion for comparison between coefficients, the specifying unit 20 may calculate, for example, a positive coefficient average value, a negative coefficient average value, a coefficient adoption rate, a positive coefficient adoption rate, a negative coefficient adoption rate, or the like in the predictive formula included in the predictive model. For example, these values are calculated as follows.

Positive coefficient average value=(positive coefficient total value)/(the number of variables having positive coefficients).

Negative coefficient average value=(negative coefficient total value)/(the number of variables having negative coefficients).

Coefficient adoption rate=(the number of variables having coefficients)/(the total number of variables).

Positive coefficient adoption rate=(the number of variables having positive coefficients)/(the total number of variables).

Negative coefficient adoption rate=(the number of variables having negative coefficients)/(the total number of variables).

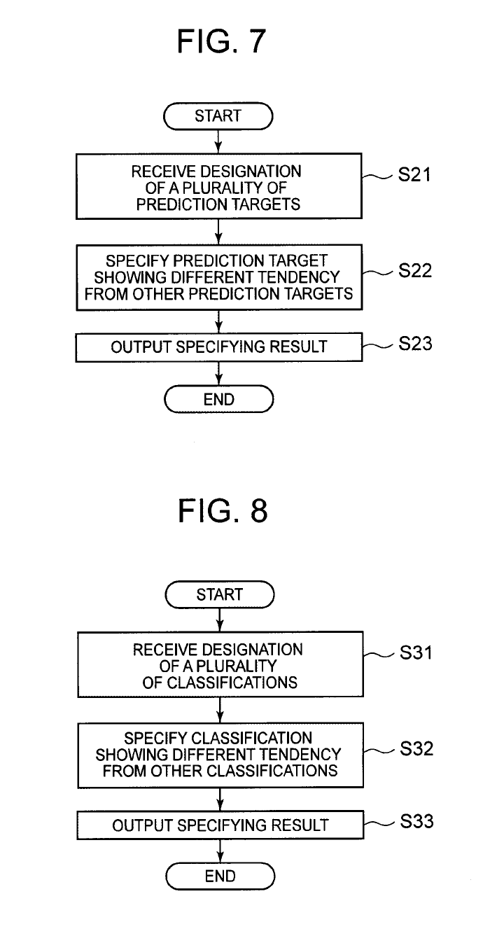

The operation of the information processing system in this exemplary embodiment is described below. FIG. 7 is a flowchart depicting an operation example of the information processing system 100 in Exemplary Embodiment 2. First, the reception unit 10 receives designation of a plurality of prediction targets (step S21).

Next, the specifying unit 20 specifies, from among the designated plurality of prediction targets, a prediction target for which an element included in the corresponding predictive model shows a different tendency from the other prediction targets (step S22). The output unit 40 outputs the specifying result (step S23).

As described above, in this exemplary embodiment, the reception unit 10 receives designation of a plurality of prediction targets. The specifying unit 20 specifies, from among the designated plurality of prediction targets, a prediction target for which an element included in the corresponding predictive model shows a different tendency from the other prediction targets. With such a structure, too, a specific prediction target can be specified from among a plurality of prediction targets.

In detail, in this exemplary embodiment, the reception unit 10 does not receive designation of an element included in a predictive model, and therefore the specifying unit 20 can specify a specific prediction target without depending on a particular element, as compared with Exemplary Embodiment 1.

### Exemplary Embodiment 3

Exemplary Embodiment 3 of an information processing system according to the present invention is described below. This exemplary embodiment describes a method of specifying a specific prediction target group when comparing groups into which prediction targets are classified. A concrete example of specifying such a prediction target group corresponds to the above-mentioned third object example. The structure in this exemplary embodiment is the same as the structure in Exemplary Embodiment 1.

The reception unit 10 receives designation of a plurality of classifications. The reception unit 10 may receive designation of the plurality of classifications individually, or receive designation of an upper classification including the plurality of subclassifications. For example, in the case where there are the prediction targets depicted in FIG. 2, the reception unit 10 may receive “fruit juice beverage”, “coffee”, “carbonated beverage”, and “mineral water” individually as prediction target classifications, or receive “beverage” which is an upper classification of these classifications. The reception unit 10 may also receive designation of an element (perspective for finding an exception) subjected to analysis, as described in Exemplary Embodiment 1.

The specifying unit 20 specifies a prediction target classification based on the designation received by the reception unit 10, and specifies the predictive models of the specified prediction targets. For example, suppose the storage unit 30 stores the prediction targets depicted in FIG. 2 and the predictive models depicted in FIG. 3. In the case where the reception unit 10 receives designation of the classifications “fruit juice beverage” and “coffee”, the specifying unit 20 specifies, from among the prediction targets depicted in FIG. 2, the prediction targets identified by prediction target IDs=1 to 10 whose classifications are “fruit juice beverage” or “coffee”. The specifying unit 20 then specifies, from among the predictive models depicted in FIG. 3, the predictive models corresponding to the specified prediction target IDs=1 to 10.

In the case where the reception unit 10 receives designation of the classification “beverage”, on the other hand, the specifying unit 20 specifies, from among the prediction targets depicted in FIG. 2, “fruit juice beverage”, “coffee”, “carbonated beverage”, and “mineral water” which are the subclassifications of the classification “beverage”, and specifies the prediction targets identified by prediction target IDs=1 to 20. The specifying unit 20 then specifies, from among the predictive models depicted in FIG. 3, the predictive models corresponding to the specified prediction target IDs=1 to 20.

The specifying unit 20 specifies, from among the designated prediction target classifications, a classification for which an element included in a predictive model corresponding to an included prediction target shows a different tendency from the other classifications, the included prediction target being included in the classification. In the case where the reception unit 10 also receives designation of the element subjected to analysis, the specifying unit 20 summarizes the tendency from the designated perspective (explanatory variable) for the prediction target group of each classification. The tendency can be summarized by the same method as the method whereby the specifying unit 20 compares tendencies between predictive models in Exemplary Embodiment 1.

For example, in the case of using “category-type determination criterion” described in Exemplary Embodiment 1, the specifying unit 20 may summarize the category proportion (0, 1, or 2) based on the type of the designated variable for the included prediction target group of each classification. The specifying unit 20 may then specify a classification for which the summarized classification tendency is different from the tendencies of the other classifications (e.g. the proportion is different).

In the case where the reception unit 10 does not receive designation of the element subjected to analysis, the specifying unit 20 summarizes the tendency for the prediction target group included in each classification. The tendency can be summarized by the same method as the method whereby the specifying unit 20 compares tendencies between predictive models in Exemplary Embodiment 2. For example, the specifying unit 20 may summarize the proportion of the explanatory variable described in Exemplary Embodiment 2 for each classification, and specify a classification for which the summarized classification tendency is different from the tendencies of the other classifications.

The specifying unit 20 may use, as a determination criterion for comparison between coefficients, a positive coefficient average value, a negative coefficient average value, a coefficient adoption rate, a positive coefficient adoption rate, or a negative coefficient adoption rate of a predictive formula described in Exemplary Embodiment 2. In detail, the specifying unit 20 may calculate such a coefficient value for each predictive model included in each classification, and calculate an average value, a standard deviation, or the like of the whole classification, to specify a classification showing a different tendency from the other classifications.

The operation of the information processing system in this exemplary embodiment is described below. FIG. 8 is a flowchart depicting an operation example of the information processing system 100 in Exemplary Embodiment 3. First, the reception unit 10 receives designation of a plurality of classifications (step S31).

Next, the specifying unit 20 specifies, from among the designated prediction target classifications, a classification for which an element included in a predictive model corresponding to an included prediction target shows a different tendency from the other classifications (step S32). The output unit 40 outputs the specifying result (step S33). For example, the output unit 40 may output the name of the classification that differs in tendency from the other classifications, or output the prediction targets belonging to the classification. Alternatively, the output unit 40 may output all of the designated prediction target classifications and highlight the classification that differs in tendency from the other classifications.

As described above, in this exemplary embodiment, the reception unit 10 receives designation of predictive model classifications. The specifying unit 20 specifies, from among the designated predictive model classifications, a classification for which an element included in a predictive model corresponding to an included prediction target shows a different tendency from the other classifications. With such a structure, specific prediction targets can be recognized globally.

### Exemplary Embodiment 4

Exemplary Embodiment 4 of an information processing system according to the present invention is described below. The structure in Exemplary Embodiment 4 is the same as the structure in Exemplary Embodiment 1. In this exemplary embodiment, however, it is assumed that each predictive model is represented by a decision tree. An example of a predictive model represented by a decision tree is a decision tree for determining whether or not 100 or more units of a product can be sold.

The reception unit 10 receives designation of a plurality of prediction targets, as in Exemplary Embodiments 1 to 3. The reception unit 10 may also receive designation of an element (perspective for finding an exception) subjected to analysis.

The specifying unit 20 specifies a prediction target based on the designation received by the reception unit 10, and specifies the predictive model of the specified prediction target. In this exemplary embodiment, the specifying unit 20 specifies a prediction target for which the type of the variable included in the corresponding predictive model or the position of the variable in the decision tree shows a different tendency from the other elements.

A leaf node of the decision tree represents a predictive value of an objective variable corresponding to a value of a variable specified based on a path from a root node. A variable is set in a node (inner node) other than a leaf node, and each branch indicates a possible value of the variable. Hence, the specifying unit 20 may specify a predictive model for which the type of the variable set in the inner node shows a different tendency from the other elements, and specify the prediction target corresponding to the predictive model. In detail, the specifying unit 20 may specify a prediction target based on whether or not a given explanatory variable is present.

For example, suppose beverage X is sold in 26 stores of {A store, B store, C store, . . . , Z store}, and, for each store, a decision tree is used to determine whether or not the sales amount exceeds 100. Also suppose 25 stores of A store to Y store all include the explanatory variable “maximum temperature” in the decision tree, whereas Z store does not include the explanatory variable “maximum temperature” in the decision tree. In such a case, the specifying unit 20 specifies the decision tree of Z store as an exception.

Further, the specifying unit 20 may specify a prediction target for which the position, in the decision tree, of the variable included in the corresponding predictive model shows a different tendency from the other elements. In detail, the specifying unit 20 may specify a prediction target based on where in the decision tree a given explanatory variable is located (whether closer to a root or closer to a leaf).

For example, suppose all of A store to Z store include the explanatory variable “maximum temperature” in the decision tree. Also suppose A store to Y store include the explanatory variable “maximum temperature” in a node closer to a root, whereas Z store includes the explanatory variable “maximum temperature” at a position very close to a leaf node. An explanatory variable included in a node closer to a root is considered to be a more important explanatory variable in the decision tree. Accordingly, the specifying unit 20 specifies the decision tree of Z store as an exception in such a case.

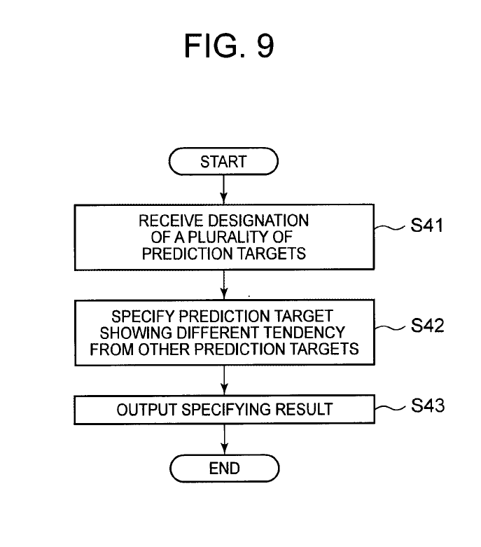

The operation of the information processing system in this exemplary embodiment is described below. FIG. 9 is a flowchart depicting an operation example of the information processing system 100 in Exemplary Embodiment 4. First, the reception unit 10 receives designation of a plurality of prediction targets (step S41).

Next, the specifying unit 20 specifies a prediction target for which the type of a variable included in the corresponding predictive model or the position of the variable in the decision tree shows a different tendency from the other elements (step S42). The output unit 40 outputs the specifying result (step S43).

As described above, in this exemplary embodiment, in the case where each predictive model is represented by a decision tree, the specifying unit 20 specifies a prediction target for which the type of a variable included in the corresponding predictive model or the position of the variable in the decision tree shows a different tendency from the other elements. With such a structure, too, a specific prediction target can be specified from among a plurality of prediction targets.

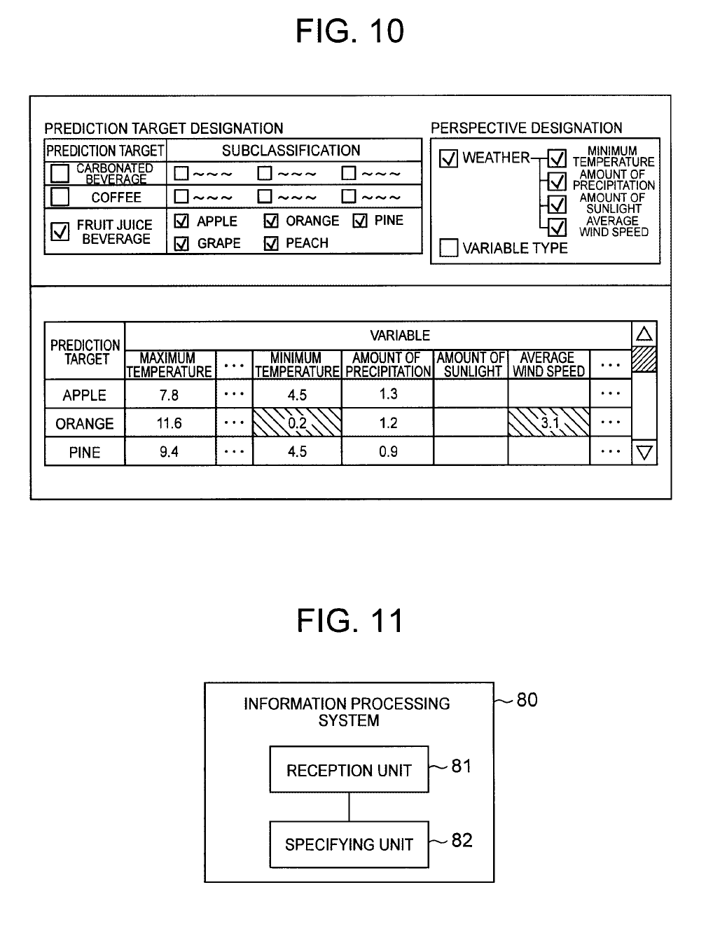

A concrete example of an output result is described below. FIG. 10 is an explanatory diagram depicting an example of an output result screen output from the output unit 40. The screen depicted in FIG. 10 includes three regions. The upper left region (hereafter referred to as “first region”) in the screen is a region for receiving designation of prediction targets. The upper right region (hereafter referred to as “second region”) in the screen is a region for receiving designation of a perspective for finding an exception. The lower region (hereafter referred to as “third region”) in the screen is a region for displaying an exception.

First, the user designates prediction targets in the first region. In the first region in FIG. 10, checkboxes for receiving designation for respective hierarchical levels in which prediction targets are classified are displayed. In the example depicted in FIG. 10, the user selects “fruit juice beverage” which is an upper classification. Note that, in the case where the user designates an upper classification, the reception unit 10 may determine that designation of all prediction targets (apple juice, orange juice, pine juice, grape juice, peach juice) belonging to the subclassifications of the upper classification is received, and the output unit 40 may automatically display that all prediction targets belonging to the subclassifications are designated.

There is a possibility that many subclassifications belong to one upper classification. The method of displaying the first region in FIG. 10 is merely an example of the subclassification display method, and the output unit 40 may, for example, perform scroll display of only the part of the region for displaying the subclassifications, or switch to another screen to display the subclassifications.

Next, the user designates a perspective for finding an exception, in the second region. In the second region in FIG. 10, checkboxes for receiving designation for respective perspective (explanatory variable) groups described in the modification of Exemplary Embodiment 1 are displayed. In the second region, a checkbox (variable type) for such a case where designation of an element is not received as described in Exemplary Embodiment 2 is also displayed.

In the example depicted in FIG. 10, the user selects “weather” which is a group. Note that, in the case where the user designates a group, the reception unit 10 may determine that designation of all variables (minimum temperature, amount of precipitation, amount of sunlight, average wind speed) belonging to the group is received, and the output unit 40 may automatically display that all variables belonging to the group are designated.

When prediction targets and a perspective for finding an exception are designated, the specifying unit 20 specifies, from among the designated plurality of prediction targets, a prediction target for which the element included in the corresponding predictive model shows a different tendency from the other prediction targets. The output unit 40 outputs the specifying result in the third region.

For example, the output unit 40 displays exceptional predictive models in the form depicted in FIG. 3. In the third region depicted in FIG. 10, the prediction targets are displayed in the left heading of the table, and the variable is displayed in the upper heading of the table. The coefficient of the variable in the predictive model corresponding to the prediction target is displayed in each cell of the table.

For example, in the case where a variable for finding an exception is designated in the second region as described in Exemplary Embodiment 1, the output unit 40 highlights the designated variable in the upper heading of the table over the other variables. The output unit 40 also highlights the cell of each exceptional coefficient displayed in the corresponding cell of the table. The output unit 40 highlights, for example, a prediction target having a coefficient showing a different tendency from the other coefficients with regard to a given explanatory variable, or a prediction target having such an explanatory variable, as an exception. For example, in the case where a variable is not designated as described in Exemplary Embodiment 2, the output unit 40 highlights a field of each exceptional prediction target in the left heading of the table.

The example depicted in FIG. 10 especially relates to an output example in each of Exemplary Embodiment 1, its modification, and Exemplary Embodiment 2. Besides the constituent elements of the screen depicted in FIG. 10, an input field for receiving designation of a plurality of classifications by the reception unit 10 or a display field for displaying an output result in a decision tree may be provided so that the output unit 40 can also output the same screen as that depicted in FIG. 10 in Exemplary Embodiment 3 or 4.

An overview of the present invention is given below. FIG. 11 is a block diagram schematically depicting an information processing system according to the present invention. An information processing system 80 according to the present invention is an information processing system 80 (e.g. the information processing system 100) for predicting a prediction target using a predictive model including a variable that influences the prediction target, the information processing system including: a reception unit 81 (e.g. the reception unit 10) which receives designation of a plurality of prediction targets; and a specifying unit 82 (e.g. the specifying unit 20) which specifies, from among the designated plurality of prediction targets, a prediction target for which an element included in a corresponding predictive model shows a different tendency from other prediction targets.

With such a structure, a specific prediction target can be specified from among a plurality of prediction targets.

The reception unit 81 may receive designation of an element included in a predictive model, and the specifying unit 82 may specify a prediction target for which the designated element shows a different tendency from other prediction targets.

A predictive model may be represented by a linear regression equation, and the specifying unit 82 may specify a prediction target for which a type of a variable included in a corresponding predictive model or a coefficient of the variable shows a different tendency from other elements.

The information processing system 80 may include an output unit (e.g. the output unit 40) which outputs a specifying result by the specifying unit 82, the specifying unit 82 may calculate a standard deviation of a coefficient of a variable in a predictive model, and the output unit may output a standard deviation calculated for each predictive model, in a heat map. With such a structure, the user can easily recognize a prediction target showing a different tendency from the other prediction targets.

A predictive model may be represented by a decision tree, and the specifying unit 82 may specify a prediction target for which a type of a variable included in a corresponding predictive model or a position of the variable in the decision tree shows a different tendency from other elements.

The reception unit 81 may receive designation of prediction target classifications, and the specifying unit 82 may specify, from among the designated prediction target classifications, a classification for which an element included in a predictive model corresponding to an included prediction target shows a different tendency from other classifications, the included prediction target being included in the classification. With such a structure, analysis can be performed from a more global perspective.

### REFERENCE SIGNS LIST

10 reception unit

20 specifying unit

30 storage unit

40 output unit

100 information processing system

1. An information processing system for predicting a prediction target using a predictive model including a variable that influences the prediction target, the information processing system comprising:
a hardware including a processor;
a reception unit, implemented by the processor, which receives designation of a plurality of prediction targets; and
a specifying unit, implemented by the processor, which specifies, from among the designated plurality of prediction targets, a prediction target for which an element included in a corresponding predictive model shows a different tendency from other prediction targets.

2. The information processing system according to claim 1, wherein the reception unit receives designation of an element included in a predictive model, and
wherein the specifying unit specifies a prediction target for which the designated element shows a different tendency from other prediction targets.

3. The information processing system according to claim 1, wherein a predictive model is represented by a linear regression equation, and
wherein the specifying unit specifies a prediction target for which a type of a variable included in a corresponding predictive model or a coefficient of the variable shows a different tendency from other elements.

4. The information processing system according to claim 3, comprising
an output unit which outputs a specifying result by the specifying unit,
wherein the specifying unit calculates a standard deviation of a coefficient of a variable in a predictive model, and
wherein the output unit outputs a standard deviation calculated for each predictive model, in a heat map.

5. The information processing system according to claim 1, wherein a predictive model is represented by a decision tree, and
wherein the specifying unit specifies a prediction target for which a type of a variable included in a corresponding predictive model or a position of the variable in the decision tree shows a different tendency from other elements.

6. The information processing system according to claim 1, wherein the reception unit receives designation of prediction target classifications, and
wherein the specifying unit specifies, from among the designated prediction target classifications, a classification for which an element included in a predictive model corresponding to an included prediction target shows a different tendency from other classifications, the included prediction target being included in the classification.

7. An information processing method for predicting a prediction target using a predictive model including a variable that influences the prediction target, the information processing method comprising:
receiving designation of a plurality of prediction targets; and
specifying, from among the designated plurality of prediction targets, a prediction target for which an element included in a corresponding predictive model shows a different tendency from other prediction targets.

8. The information processing method according to claim 7, wherein designation of an element included in a predictive model is received, and
wherein a prediction target for which the designated element shows a different tendency from other prediction targets is specified.

9. A non-transitory computer readable information recording medium storing an information processing program used in a computer for predicting a prediction target using a predictive model including a variable that influences the prediction target, when executed by a processor, the information processing program performs a method for:
receiving designation of a plurality of prediction targets; and
specifying, from among the designated plurality of prediction targets, a prediction target for which an element included in a corresponding predictive model shows a different tendency from other prediction targets.

10. The non-transitory computer readable information recording medium according to claim 9,
receiving designation of an element included in a predictive model, and
specifying a prediction target for which the designated element shows a different tendency from other prediction targets.
